(19) United States
(12) Patent Application Publication
(10) Pub. No.: US 2006/0109096 A1
(43) Pub. Date: May 25, 2006

(54) Separate gauge body for vehicle

(76) Inventor: Shih-Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/994,383

(22) Filed: Nov. 23, 2004

(51) Int. Cl. B60Q 1/00

(52) U.S. Cl. 340/438

(57) ABSTRACT

A gauge for a vehicle includes an electric device and a gauge body separate from the electric device. The gauge body includes a housing separate from the electric device and at least one indicating device mounted in the housing. The electric device and the gauge body are connected by a cable and at least one connection port in at least one of the electric device and the gauge body to allow easy detachment. A transmission device is mounted in the housing and driven by the electric device.

### BACKGROUND OF THE INVENTION

1. Field of the Invention

The present invention relates to a gauge body. In particular, the present invention relates to a gauge body for a vehicle.

2. Description of the Related Art

A vehicle such as an automobile includes a plurality of gauges including a tachometer, a speedometer, an odometer, a gas gauge, etc. As illustrated in FIG. 1 of the drawings, a gauge 1 comprises an electric device 11 and a gauge body 12 housed in a casing. The electric device 11 includes electric circuits for handling, operation, and driving as well as at least one cable. The gauge body 12 comprises at least one indicating device of digital type, pointer type, or pattern type. The indicating device is driven, with transmission by a transmission device, by the electric circuits to provide an indication. However, the whole gauge 1 must be detached for repair or maintenance, as the electric device 11 and the body 12 are mounted in the same casing. Further, the whole gauge 1 must be detached even the user only wants to change the appearance.

### SUMMARY OF THE INVENTION

An objective of the present invention is to provide a gauge body that is separate from the electric device to allow easy detachment and maintenance.

In accordance with an aspect of the invention, a gauge for a vehicle comprises an electric device and a gauge body separate from the electric device. The gauge body includes a housing separate from the electric device and at least one indicating device mounted in the housing. The electric device and the gauge body are connected by a cable and a connection port in at least one of the electric device and the gauge body to allow easy detachment.

In an embodiment of the invention, the gauge body includes a transmission device mounted in the housing and driven by the electric device. The transmission member may be a step motor.

Since the gauge body is separate from the electric device, maintenance and repair of the gauge is convenient.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic view illustrating a conventional gauge for a vehicle.

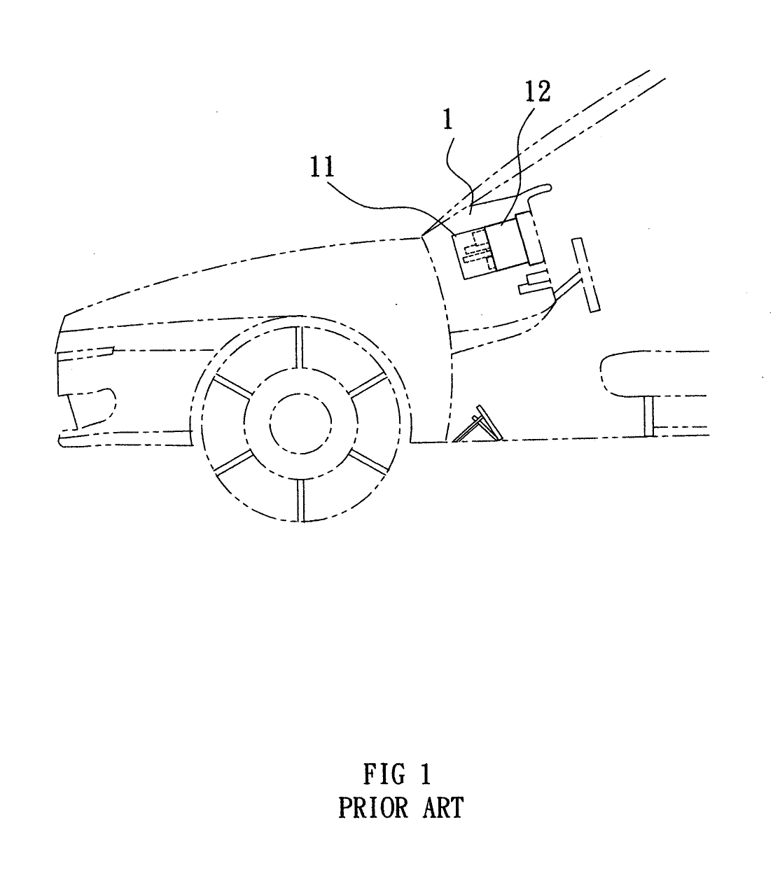

FIG. 2 is a perspective view of a gauge in accordance with the present invention.

FIG. 3 is an exploded perspective view of a gauge in accordance with the present invention.

FIG. 4 is a schematic view illustrating mounting of the gauge in accordance with the present invention.

### DETAILED DESCRIPTION OF THE PREFERRED EMBODIMENT

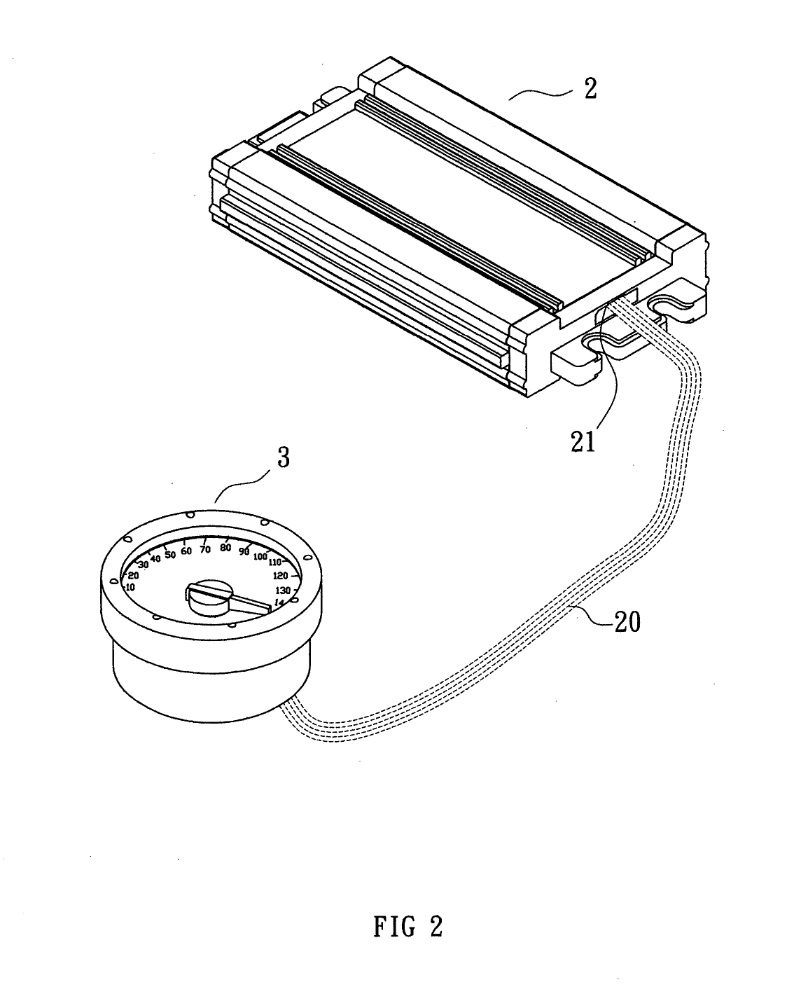

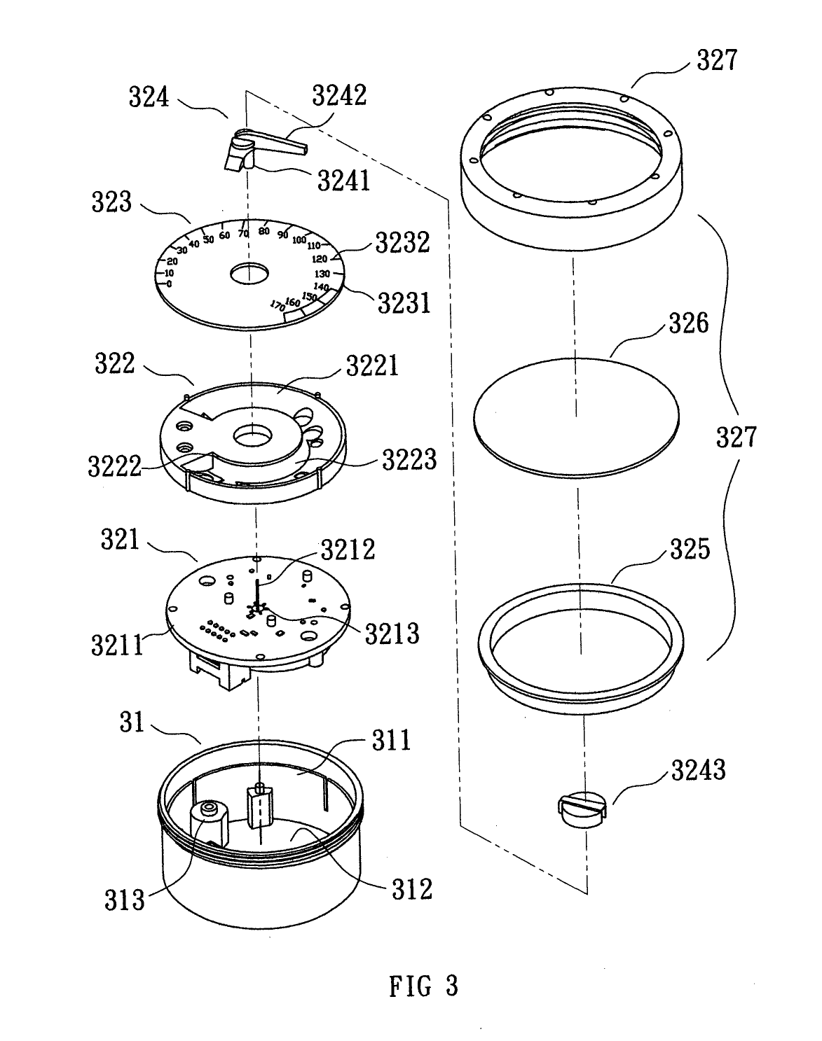

Referring to FIGS. 2 and 3, a gauge 1 in accordance with the present invention comprises an electric device 2 and a gauge body 3 that is separate from the electric device 2. The gauge body 3 comprises a housing 31 separate from the electric device 2 and an indicating device 32 mounted in the housing 31. The electric device 2 includes electric circuits for handling, operation, and driving as well as at least one cable. The electric device 2 and the gauge body 3 are connected by a cable 20 and at least one connection port in at least one of the electric device 2 and the gauge body 3 (see the connection port 21 in the electric device 2) to allow easy detachment.

The housing 31 includes a peripheral wall 311 that defines a compartment 312 for receiving elements. A transmission member 313 is mounted in the housing 31. In the illustrated embodiment, the transmission member 313 is a step motor electrically connected to and driven by the electric device 2.

The indicating device 32 comprises a lamp board 321, a light guiding board 322, a display board 323, an indicator 324, an inner ring 325, a glass pane 326, and an outer ring cover 327. The lamp board 321 includes a board 3211 having a shaft 3212 that is driven by the transmission member 313. At least one lighting element 3213 (such as light-emitting diode) is mounted on the board 3211 and adjacent to the shaft 3212.

The light guiding board 322 is mounted between the lamp board 321 and the display board 323. The light guiding board 322 includes an arc-shaped slope 3221 that declines inward along a portion of an inner periphery thereof. A shield plate 3222 extends inward from the remaining portion of the inner periphery of the light guiding board 322, forming an opening 3223 through which the light from the lighting element 3213 passes to illuminate the arc-shaped slope 3221.

The display board 323 includes a board 3231 on which at least one scale 3232 is provided. The bottom of the plate 3231 is illuminated by the light incident on the arc-shaped slope 3221. The indicator 324 is in the from of a pointer including a vertical portion 3241 coupled with the shaft 3212 and a horizontal portion 3242. A shield cap 3243 is mounted on top of the vertical portion 3241 such that the light from the lighting element 3213 travels vertically upward along the vertical portion 3241 and then scatters along the horizontal portion 3242 after incident on the shield cap 3243. The horizontal portion 3242 is thus illuminated. The horizontal portion 3242 may include a light-shielding layer (not shown).

The inner ring 325 retains the display board 323 in place. The glass pane 326 is transparent and mounted on top of the display board 323 for protection purposes. The outer ring cover 327 retains the glass pane 326 in place.

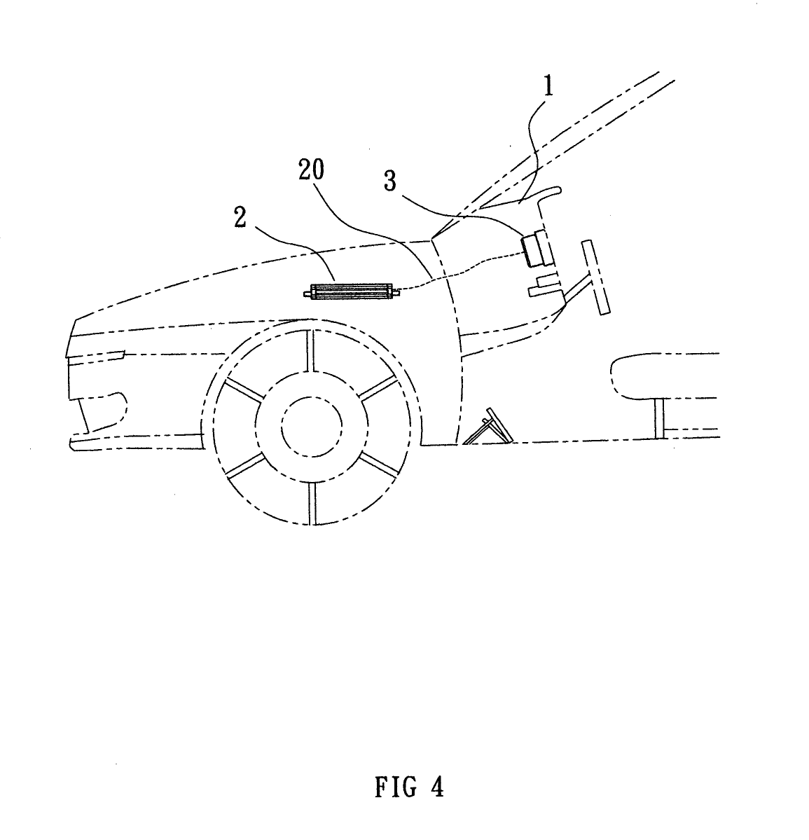

FIG. 4 illustrates mounting of the gauge 1 in accordance with the present invention in a vehicle. Since the gauge body 3 is separate from the electric device 2, maintenance and repair of the gauge 1 is convenient. Further, since there are many gauges in the vehicle, arrangement of the gauges is more flexible as the gauge body of each gauge is separate from the electric device of each gauge.

Although a specific embodiment ha been illustrated and described, numerous modifications and variations are still possible without departing from the essence of the invention. The scope of the invention is limited by the accompanying claims.

What is claimed is:

1. A gauge for a vehicle comprising:
an electric device separate from the electric device; and
a gauge body separate from the electric device, the gauge body including a housing separate from the electric device and at least one indicating device mounted in the housing, the electric device and the gauge body being connected by a cable and at least one connection port in at least one of the electric device and the gauge body to allow easy detachment.

2. The gauge for a vehicle as claimed in claim 1 wherein the gauge body further includes a transmission device mounted in the housing and driven by the electric device.

3. The gauge for a vehicle as claimed in claim 2 wherein the transmission member is a step motor.
